(19) United States
(12) Patent Application Publication
(10) Pub. No.: US 2009/0299977 A1
(43) Pub. Date: Dec. 3, 2009

(54) Method for Automatic Labeling of Unstructured Data Fragments From Electronic Medical Records

(75) Inventor: Romer E. Rosales, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/469,745

(22) Filed: May 21, 2009

Related U.S. Application Data
(60) Provisional application No. 61/056,509, filed on May 28, 2008.

(51) Int. Cl. G06F 17/30; G06F 7/00; G06Q 50/00

(52) U.S. Cl. 707/3; 707/100; 705/3; 707/E17.014; 707/E17.044; 707/E17.009

(57) ABSTRACT

A method for automatically labeling unstructured data from electronic medical records using a computer-based medical data processing system includes selecting a data pattern based on a desired medical finding. The selected data pattern is searched for within source data including patient records to find one or more matches. A context of a predetermined range around each data pattern match found is identified within the source data and the found contexts are associated with a particular medical finding. The medical finding can be at the patient level or document level, not necessarily at the context level. Associations between contexts and medical findings are identified. A classifier based on an association between the identified contexts and the desired medical finding is trained. The trained classifier is used to automatically identify likely instances of passages, documents or patients related to the desired medical finding from within subsequent data including patient records.

### CROSS-REFERENCE TO RELATED APPLICATION

The present application is based on provisional application Ser. No. 61/056,509, filed May 28, 2008, the entire contents of which are herein incorporated by reference.

### BACKGROUND OF THE INVENTION

1. Technical Field

The present disclosure relates to electronic medical records and, more specifically, to methods for automatic labeling of unstructured data fragments from electronic medical records.

2. Discussion of Related Art

Electronic medical records (EMR) are patient records pertaining to medical conditions, states, diagnoses, procedures, treatment and billing that are electronically accessible. EMRs may be stored and/or maintained in a hospital database or via other archiving means. An EMR database may include multiple patient records, with each record including a number of data fields and corresponding field values. EMRs may include information such as the patient's personal information, doctor notes, lab reports, diagnosed diseases, and courses of treatment performed. The included information may contain structured and unstructured data. Structured data includes data that is organized by specific headings and labels that are easily interpretable by a computer system. For example, structured data may include a field called, “patient name” that includes only the name of the patient. Structured data may also include a patient ID number and various diagnosis and billing codes.

Examples of commonly used diagnosis codes include ICD9 codes, where there is one unique code number associated to one of a wide range of possible diagnoses. Examples of commonly used billing codes include CPT codes, where there is one unique code number for a wide range of medical efforts such as examinations and procedures.

EMRs may also include unstructured data. Unstructured data includes data that may be associated to a general heading or data field such as consultation notes. Ideally all data would be structured; however, in practice, there are times when data either cannot easily be structured, or the effort was not taken to enter the data in a structured format.

Structured data is more easily searched to find or retrieve the appropriate information than unstructured data and thus, it is desired that data be structured to the greatest extent possible. For example, if a search is performed to find all patient records from patients who smoke tobacco, if a diagnosis for tobacco smoking is entered into the EMRs in a structured form, for example, as an ICD9 code, a computer system may be able to quickly and easily search though voluminous patient records and identify all patients that smoke tobacco. If, however, this information is part of patient records as unstructured data, for example, in the form of a plain-language consultation note, it may be very difficult to determine whether a particular patient is a tobacco smoker.

In addition to data that has been entered as a natural-language text filed, data may be unstructured where the patient record was originally generated from a paper file that has been scanned into electronic form or where the patient record was originally generated from an electronic system with tags and fields that are not understood by the current EMR system being used. Other examples of unstructured data include images. Because today, a great deal of patient records include unstructured data, it is desirable that unstructured data be converted into structured data for more efficient processing. However, the process of converting unstructured data to structured data generally involves the manual review and tagging of the unstructured data. The costs associated with such an endeavor are generally prohibitive. Accordingly, it is desired that methods be utilized for automatically labeling unstructured data fragments from electronic medical records.

### SUMMARY

A method for automatically labeling unstructured data from electronic medical records using a computer-based medical data processing system includes selecting a data pattern based on a desired medical finding. The selected data pattern is searched for within source data including patient records. A context of a predetermined range around each data pattern match found is identified within the source data. A classifier based on an association between the identified contexts and the desired medical finding is trained. The trained classifier is used to automatically identify likely instances of the desired medical finding from within subsequent data including patient records.

The data pattern may be selected from one or more words relating to the desired medical finding. The one or more words may be selected from a description of the desired medical finding. The predetermined range may be a fixed number of words or characters preceding and following the data pattern.

The source data may include a medical image and the data pattern may be a particular shape or other image appearance. The predetermined range may be a surrounding area or volume of a fixed perimeter about the data pattern.

The desired medical finding may be a diagnosis, condition, symptom or other medical concept of interest.

The source data may include structured data indicating whether or not the desired medical finding is present and the subsequent data does not include structured data indicating whether or not the desired medical finding is present.

The classifier may be trained using a machine learning technique.

Structured data indicating whether or not the desired medical finding is present may be added to the subsequent.

A method for automatically labeling unstructured data from electronic medical records using a computer-based medical data processing system includes receiving patient medical data that does not include structured data indicating whether or not a desired medical finding is present. A data pattern indicative of the desired medical finding is searched for from within the patient medical data. A context of a predetermined range is identified around each data pattern match found within the patient medical data. A trained classifier is used to automatically identify whether the patient medical data has the desired medical finding based on the identified contexts, wherein the trained classifier was generated based on an association between identified contexts and the desired medical finding within training data.

The data pattern may be selected from one or more words relating to the desired medical finding. The one or more words may be selected from a description of the desired medical finding. The predetermined range may be a fixed number of words or characters preceding and following the data pattern.

The desired medical finding may be a diagnosis, condition, symptom or other medical concept of interest.

The training data may include structured data indicating whether or not the desired medical finding is present and the patient medical data does not include structured data indicating whether or not the desired medical finding is present.

Structured data indicating whether or not the desired medical finding is present may be added to the patient medical data.

A computer system includes a processor and a program storage device readable by the computer system, embodying a program of instructions executable by the processor to perform method steps for automatically labeling unstructured data from electronic medical records. The method includes selecting a data pattern based on a desired medical finding, searching for the selected data pattern within source data including patient records, identifying a context of a predetermined range around each data pattern match found within the source data, training a classifier based on an association between the identified contexts and the desired medical finding using a machine learning technique, and using the trained classifier to automatically identify likely instances of the desired medical finding from within subsequent data including patient records.

The source data may include structured data indicating whether or not the desired medical finding is present and the subsequent data does not include structured data indicating whether or not the desired medical finding is present.

Structured data indicating whether or not the desired medical finding is present may be added to the subsequent data.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for the automatic labeling of unstructured data fragments according to an exemplary embodiment of the present invention;

FIG. 2 is a series of tables illustrating an example of how unstructured data fragments may be automatically labeled according to the approach illustrated in FIG. 1;

FIG. 3 is a flow chart illustrating an approach for using correlated patterns in context to automatically label subsequent unstructured data according to exemplary embodiments of the present invention; and

FIG. 4 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to automatically label unstructured data fragments (in the case of text-based unstructured data, they are also referred to as passages, sentences, or in general as context) from electronic medical records so that data within electronic records may be efficiently utilized, even in cases in which that data was not manually structured. Automatic labeling may thus be used to upgrade or extend the structure of patient medical records and/or for the purposes of performing a search (e.g., based on the labeling and/or the text combined) on patient medical records.

Conventional approaches for automatically structuring patient medical records may involve searching the entire text of patient medical records key phrases that are believed, by a human programmer, such as expert personnel, to be indicative of various “medical findings.” As used herein, “medical findings” relates to diagnosed diseases, conditions, symptoms, or any other medical concept of interest. A diagnosis of a patient being a smoker is an example of a medical finding. A programmer believing that the phrase, “the patient is a smoker” is indicative of a patient that smokes may perform a search for this phrase within the entire patient medical record and will identify a particular patient as a smoker only when this exact phrase is found. This approach suffers from key disadvantages. For example, it is burdensome for a programmer to have to produce each and every possible phrase that can identify a particular disease, and it is highly unlikely that this can be done with accuracy given the great number of different ways to express a single idea in natural language. Additionally, the task of attempting to identify a large number of whole phrases from a great number of large files can be computationally expensive, and perhaps prohibitively so.

Accordingly, exemplary embodiments of the present invention seek to create associations between elements of unstructured data and various codes and other structured data elements so that medical findings and other pertinent information may be automatically discovered, for example, at a more detailed level, such as at the context level rather than at the patient level, and reintroduced into the patient records in a structured form.

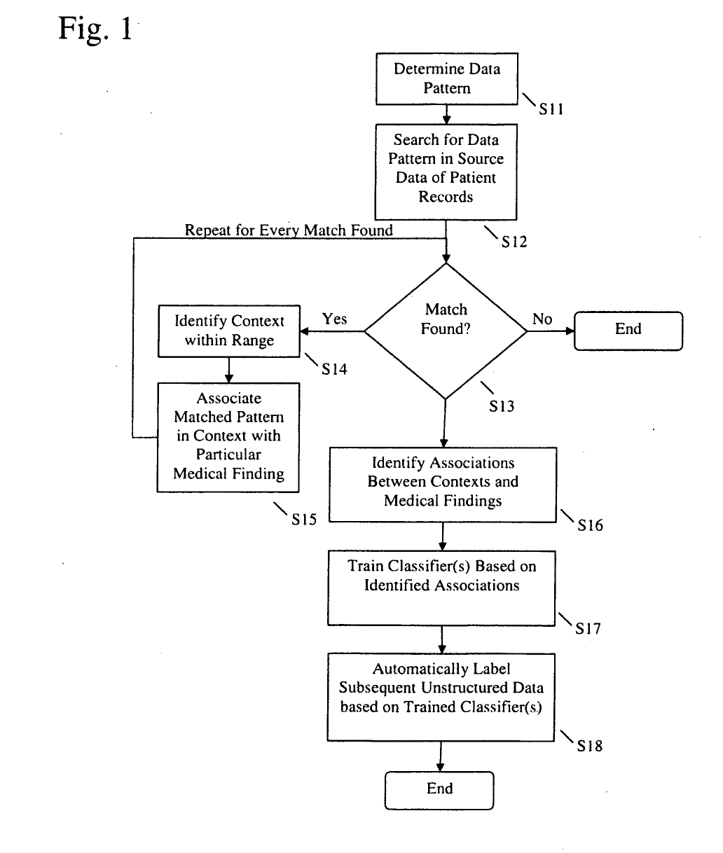

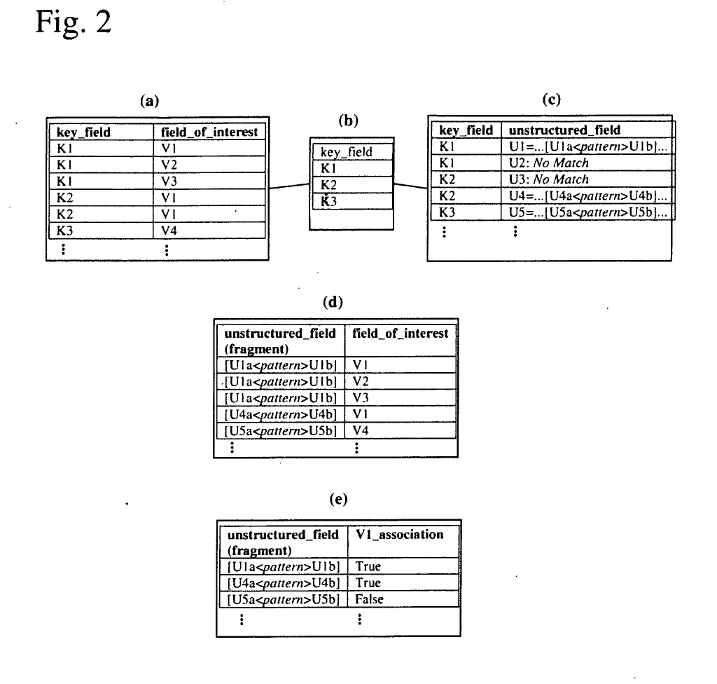

FIG. 1 is a flow chart illustrating an approach for the automatic labeling of unstructured data fragments according to an exemplary embodiment of the present invention. FIG. 2 is a series of tables further illustrating the approach of FIG. 1 by way of example. With respect to FIGS. 1 and 2, a data pattern may be determined (Step S11). The data pattern may be one or more key words but according to one exemplary embodiment of the present invention, is comprised of a sequence of one, two or three key words. The data pattern may be a regular expression as well. Regular expressions provide a concise and flexible means for identifying strings of text of interest, for example, particular characters, words, or patterns of characters. The data pattern may be manually selected or automatically selected. The purpose of the data pattern is to quickly identify one or more locations within the unstructured data fragments of the electronic medical records that may be relevant to one or more particular medical findings being searched for and accordingly, the data pattern may be relatively small and may consist of a single keyword or a portion of a word.

Exemplary embodiments of the present invention may use any means available to identify suitable data patterns. For example, a data pattern may be any one word, or a sequence of two or three words, used in defining a data field of interest corresponding to a particular medical finding being searched for. For example, where the purpose is to determine whether patients are smokers, the data pattern may be selected from a description of what it means to be a smoker, for example, based on the description of the IDC9 code for smoking or from some other medical definition of what it means to be a smoker.

According to another example, the data pattern may be selected as one or more words taken from documents for which the data field of interest has a particular value. For example, the data pattern may be taken from documents pertaining to patients with a particular ICD9 code. This may be particularly useful where exemplary embodiments of the present invention are used to automatically detect whether a particular ICD9 code is appropriate for each of a number of patients based on their medical records. Here, the data pattern may be selected from among the text of patient records that already are labeled with the ICD9 code in question. A correlation between the appearances of words within patient records exhibiting the label of interest may be calculated and used in selecting a suitable data pattern. The selected data pattern may exhibit a strong representation within the patient records that have the ICD9 label that exceeds what would be expected from a general pool of patient records. For example, the data pattern may be the top most correlated word or words. Alternatively, other measures may be used, such as mutual information or chi-squared values, between the word and the value of the field of interest.

The one or more keywords of the data pattern may be selected according to the particular medical finding being searched for. For example, if exemplary embodiments of the present invention are being used to determine if patients are smokers based on unstructured data, the word “smoking” or the word fragment “smok” may be selected as a suitable data pattern.

It is not necessary that the data patterns used be manually determined. According to exemplary embodiments of the present invention, the data patterns may be automatically selected from one or more descriptions of the particular medical finding being searched for. Other approaches for selecting data patterns may be used, and the invention should not be construed as being limited to the exemplary approaches discussed herein.

After the data pattern has been selected (Step S11), the data pattern may be searched for from within a set of source data that includes patient medical records within which the question of whether the patients have the particular medical finding being searched for is either known or knowable (Step S12). Each of the patient records of the source data may be searched for the desired data pattern. Searching the unstructured data may involve a form of sequential or more direct search for the data pattern. A single medical finding may have multiple keywords and multiple different medical findings may be searched for at the same time. Accordingly, there may be multiple data patterns being searched for at the same time. However, for the purposes of simplicity of explanation, exemplary embodiments of the present invention will be described herein in terms of searching for only a single pattern, although it is to be understood that multiple patterns may be searched for simultaneously.

The source data may be structured data that might indicate, in a computer-understandable manner, that the medical finding exists for a particular patient, for example, at the patient level. This is the most common case. Alternatively, or additionally, the structured data might indicate that the particular medical finding exists for a particular document within the electronic medical records of the particular patient, for example, at the document level. Alternatively, or additionally, the structured data might indicate that the particular medical finding exists for a particular medical image within the electronic medical records of the particular patient, for example, at the image level. However, the structured data generally does not indicate that the particular medical finding exists with respect to a given context (e.g. passage or sentence in the case of text; image region for the case of an image; or a DNA/RNA subsequence in the case of a biological sequence). Thus, even though the structured data may indicate that a particular medical finding is present, there may still be contexts within the structured data for which no label pointing to a particular medical finding is present, even though the text of the context may be understood, by a human reader, to be associated with a particular medical finding. Accordingly, the source structured data is said to lack computer-understandable labeling for a particular medical finding at the context level. Accordingly, the resulting trained classifier may be used to identify the medical finding at the patient level, the document level, the image level, or the context level.

A data pattern may be properly identified when it fully matches the searched for data pattern. However, in general, a pattern may be identified if it matches to a given extent, for example, a partial match above a particular threshold such as a percentage, probability, or filter response value.

In terms of the tables of FIG. 2, the data pattern being searched for is represented as “<pattern>” and the patient medical record identifications are represented as the key values K1, K2, K3, etc., as can be seen in table (b) of FIG. 2. Accordingly, each key value represents a distinct patient medical record. In the example provided herein, there are three distinct patient medical records shown, with identifier values K1, K2 and K3. The unstructured data of the patient medical records are represented as U1, U2, U3, U4, U5, etc. As each patient medical record may have multiple locations of unstructured data, there may be more unstructured data records than key identifier values. As can be seen in table (c) of FIG. 2, key value K1 has two unstructured data records U1 and U2, key value K2 has two unstructured data records U3 and U4, and value field K3 has one unstructured data record U5.

After searching for the data pattern on the source data of the patient records (Step S12), one or more matches may either be found for each key value (Yes, Step S13) or no matches may be found (No, Step S13). Where no matches are found (No, Step S13), it is understood that the patient records do not include the data pattern being searched for. Thus, the method may end here, at least with respect to the particular patient record being searched. The search may continue (Step S12) for any remaining key values that have not been searched.

In the example of FIG. 2, three matches were found in the unstructured data fragments U1, U4 and U5. According to the method illustrated in FIG. 1, for each match (Yes, Step S13), the surrounding context of the found data pattern is identified (Step S14). The context may be defined to include a predetermined number of words or characters before and after the location of the data pattern. For example, where the data pattern “smoking” is found within an unstructured data fragment, the context may include a predetermined number of words or characters immediately before and after the word “smoking” within the unstructured data fragment. The number of words or characters may be as few as one or two words or may be as large as 50 or 100 in either direction; however, exemplary embodiments of the present invention may define a context as 5, 10, 15, 20, 25, 30, or 50 words in either direction. For example, where the context is defined as 5 words in either direction, the pattern in context may be: “The patient does not consume [alcohol. The patient has been smoking for the past fifteen years.]” or “Mr. Smith indicated [that he had successfully quit smoking over five years ago. Prior] to that, Mr. Smith had been smoking as many as 3 packs of cigarettes a day.” Here the brackets indicate the context. As can be seen, the context may span multiple sentences and may begin or end in the middle of a sentence.

As illustrated in table (c) of FIG. 2, the identified context is represented as [U1a<pattern>U1b] for the match found within unstructured data fragment U1, the identified context is represented as [U4a<pattern>U4b] for the match found within unstructured data fragment U4, and the identified context is represented as [U5a<pattern>U5b] for the match found within unstructured data fragment U5. Thus, in general, “U*a” and “U*b”, where “*” indicates a particular number, are used to represent the context before and after the data pattern, respectively.

In accordance with the above disclosure, tables (a), (b), and (c) collectively represent the source data, which may be those patient records from which exemplary embodiments of the present invention use to prepare for the automatic labeling of subsequent unstructured data.

At this point, the identified data patterns in their surrounding context may be associated with a particular medical finding (Step S15). The associated medical finding may be understood from known medical finding associations, for example, as shown in table (a) of FIG. 2. Here the fields of interest contain four possible values V1, V2, V3, and V4 representing four possible medical findings. As this approach is utilized to automatically label unstructured data with particular medical findings, the data being used to associate patterns with particular medical findings is regarded as source data as it also includes data representing the medical findings in the structured data fields. Subsequent unstructured data may not have these medical findings as part of structured data. Accordingly, in this step, each identified pattern in context may be matched with a particular medical finding as provided in table (a) of FIG. 2.

The steps of identifying the context within range (Step S14) and associating matched contexts with particular medical findings (Step S15) may be repeated for every match found. By repeating these steps for each match, general associations between various contexts and medical findings may be gathered (Step S16) and by this process, training data may be collected, as these general associations may then be used to train classifiers based on the identified associations (Step S17). In identifying the associations between contexts and medical findings (Step S16), one or more tables such as tables (d) and (e) of FIG. 2 may be generated. These tables may represent the training data that is used in step S17 to train the classifiers.

For example, table (d) of FIG. 2 illustrates an association between particular matched contexts and the medical findings associated thereto. Here it is shown that the pattern in context [U1a<pattern>U1b] is found within a field that is also labeled with a medical finding V1, the pattern in context [U1a<pattern>U1b] is found within a field that is also labeled with a medical finding V2, the pattern in context [U1a<pattern>U1b] is found within a field that is also labeled with a medical finding V3, the pattern in context [U4a<pattern>U4b] is found within a field that is also labeled with a medical finding V1, and the pattern in context [U5a<pattern>U5b] is found within a field that is also labeled with a medical finding V4.

For example, table (e) of FIG. 2 illustrates an association between particular matched data patterns in context and whether their is a true association, false association, or no association at all for a particular medical finding, here illustrated for the medical finding V1 (although it is to be understood that where such a table is generated, it may be generated for all medical findings). Accordingly, based on the source data of tables (a), (b), and (c), [U1a<pattern>U1b] has a “true” association with medical finding V1, [U4a<pattern>U4b] has a “true” association with medical finding V1, and [U5a<pattern>U5b] has a “false” association with medical finding V1 indicating that contexts [U1a<pattern>U1b] and [U4a<pattern>U4b] may be indicative of medical finding V1 while the context [U5a<pattern>U5b] may be indicative of the absence of the medical finding V1. While not shown, this table may also indicate that contexts [U2a<pattern>U2b] and [U3a<pattern>U3b] have no discernable association with medical finding V1.

After the associations between contexts and medical findings have been generally identified for all patient records (Step S16), one or more classifiers may be trained (Step S17), based on the identified associations, for automatic labeling of subsequent unstructured data (Step S18).

The training of the classifier(s) (Step S17) may be performed using the generated training data, using sophisticated computer learning algorithms, or more simply, by ascertaining simple relationships between contexts and medical findings. For example, if in the subsequent data it is discovered that the particular data pattern is found within a context resembling [U1a<pattern>U1b] then the subsequent unstructured data may be labeled as having the medical condition V1, likewise if it is found within a context resembling [U4a<pattern>U4b].

According to a more sophisticated approach for automatic labeling of subsequent unstructured data, computer learning techniques may be used to train classifier(s) for the automatic detection of medical findings from subsequent unstructured data. To this end, the association between patterns in context with particular medical findings may be used as labels for building a machine learning classifier. As these associations may in general not be 100% accurate, the association may be used as “noisy” labels where the machine classifier is taught to detect the difference between contexts that correspond positively to a particular medical finding, contexts that correspond negatively to a particular medical finding, and/or contexts that do not correspond to a particular medical finding.

The process of building a machine learning classifier may involve choosing a representation of the unstructured data. Text passages may be represented using text based functions (also referred to in this disclosure as text features).

One example of an approach for representing unstructured data is to use distance based features. These features are built by computing the distance (e.g., token distance or character distance) from the location of the data pattern matched in the text fragment to the location of at least one other new pattern (different from the original pattern) matched in the passage. This representation may preserve the context to some extent, unlike the traditional word appearance representation below, which in general eliminates the context.

Another example of an approach for representing unstructured data is to use word appearance features. This representation of text is common in the natural language processing literature. These features may represent whether words or n-grams (combinations of words) appear in the text passage.

Another example of an approach for representing unstructured data is to use meta-data features. These features may incorporate information that is not inside the document text, but related to it. This may include document type, date, signature, etc.

Regardless of whether a simple approach or whether a more sophisticated approach is used to perform subsequent automatic labeling, labeling so performed may be displayed to an expert user who may be given the opportunity to browse though the automatically generated labels and correct and/or edit the labels automatically assigned to the unstructured data.

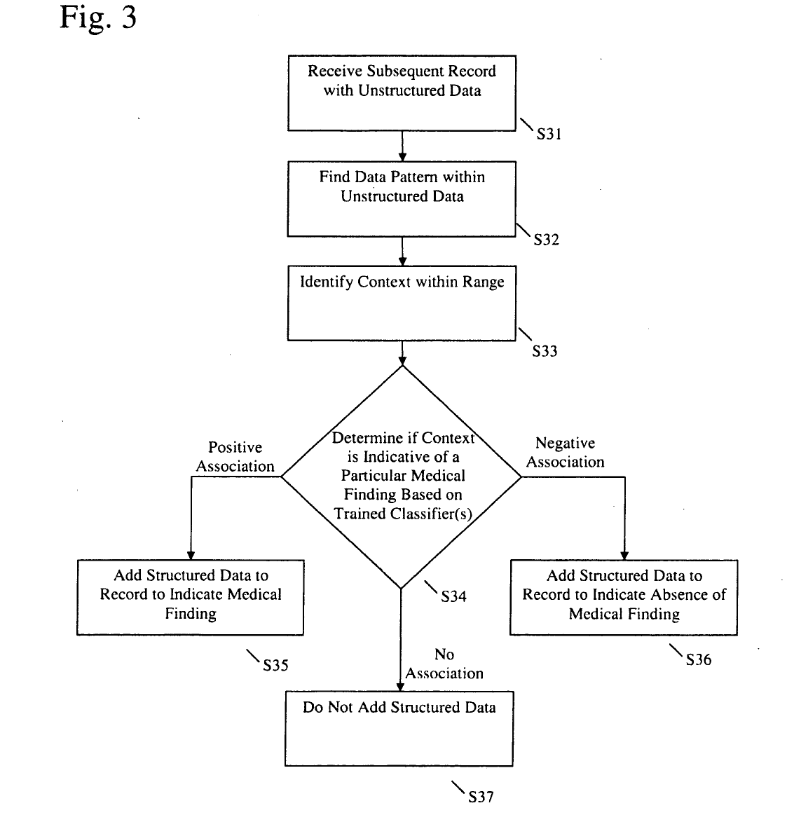

FIG. 3 is a flow chart illustrating an approach for automatically labeling subsequent unstructured data based on correlated patterns in context that have been determined in accordance with the approach of FIG. 1, according to exemplary embodiments of the present invention. Subsequent patient medical record data may be received (Step S31). This record data may be considered subsequent record data because it is received after the source data has been processed and the classifiers trained, for example, in accordance with the approach discussed in detail above. The subsequent patient medical record data may include unstructured data, for example, consultation notes and other free-form natural-language data elements. The unstructured data may then be searched though to find one or more data patterns (Step S32). The data pattern used may depend on the particular medical finding being searched for. The same data pattern(s) as were used on the source data may be used on the subsequent data. Where the data pattern is found, the context may be identified (Step S33). As with the case above, the context may be defined as a predetermined number of words or characters from either side of the data pattern. While the context range used with respect to the subsequent data may be the same length as the context range used with respect to the training data, there is no requirement that this be the case. Thus the context range used with respect to the subsequent data may be smaller than, equal to, or greater than the context range used with respect to the training data. For example, the context range may be twenty words before the data pattern to twenty words after the data pattern.

After the context has been so identified, it may be determined whether the context is indicative of a particular medical finding based on the classifiers generated during the processing of the training data (Step S34). For example, the correlation determined during the processing of the training data may include the generation of a classifier by way of a computer learning technique. In such a case, the generated classifier may be applied to the identified context to determine if the context is indicative of the particular medical finding. When it is determined that the context is positively indicative of the particular medical finding (Yes, Step S34), the particular medical finding may be added to the patient record in the form of structured data (Step S35). For example, where it is determined that the patient was a smoker, the ICD9 code for smoking may be applied to the patient record as structured data. When it is determined that the context is negatively indicative of a particular medical finding (No, Step S34), the absence of the particular medical finding may be added to the patient record in the form of structured data (Step S36). For example, where it is determined that the patient was not a smoker, the ICD9 code for non-smoking may be applied to the patient record as structured data. When the context has no correlation, positive or negatives, with the particular medical finding, structured data need not be added to the record.

In this way, or by similar approaches, the unstructured data may be automatically labeled. It should be noted that the context can be labeled in the way described (context level), but also the document or patient can be labeled in a similar manner (e.g.; by combining the context level labels).

Exemplary embodiments of the present invention need not utilize ICD9 codes in the automatic tagging of unstructured patient medical record data, however, the use of these codes provides for a simplified explanation in the disclosure and thus the examples in the disclosure may be based on the use of these codes. For example, exemplary embodiments of the present invention may seek to provide an approach for automatically determining whether a particular ICD9 code is applicable to patient medical records including unstructured text. Here the data pattern may be selected from among the description of the particular ICD9 data code, the training data may include patient medical records that have already been labeled with the particular ICD9 code, and the classifier is trained to detect whether a patient medical record is deserving of the particular ICD9 code based on unstructured data.

Exemplary embodiments of the present invention need not be limited to searching for unstructured text data. Other forms of unstructured data may also be automatically labeled according to the techniques described in detail above. For example, unstructured data may include image data such as an MR image, CT scan or other form of medical image data. In such a case, the data pattern may be an image filter, a convolution operator or, more generally, an image matching pattern. The context in such a case may be identified as an area or volume of the image data within a predetermined margin or perimeter. Computer learning algorithms may then be used to associate the image context area or volume surrounding the image data pattern to known structured data such as medical findings. Then, when subsequent unstructured data in the form of images are analyzed using classifiers constructed by the computer learning algorithm, appropriate data labels may be automatically applied as structured data.

Exemplary embodiments of the present invention such as those discussed above may include several novel features over the known approaches for labeling of unstructured data. For example, exemplary embodiments of the present invention may concentrate on the problem of classifying fragments of text with given labels that may be associated to full documents or groups of documents. These labels need not be known and may instead be automatically extracted from the one or more documents that define a particular medical finding. In addition to using features that search for the presence of a particular data pattern within a record, exemplary embodiments of the present invention may also use distance based features to represent the text fragments.

Some exemplary embodiments of the present invention may be concerned, not with automatically labeling patient medical records with structured data indicating particular medical findings, but rather with determining what contexts are associated with particular medical findings. This information may be of use in a wide variety of research and clinical applications. Accordingly, some exemplary embodiments of the present invention may end with Step 16 of FIG. 1, after associations between particular contexts and medical findings have been determined.

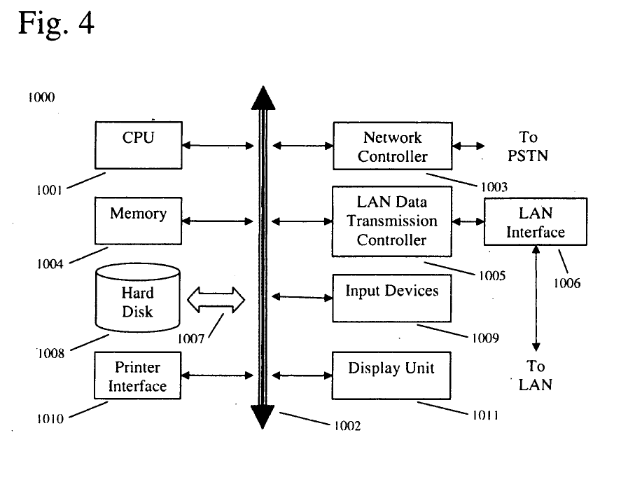

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for automatically labeling unstructured data from electronic medical records using a computer-based medical data processing system, comprising:
selecting a data pattern based on a desired medical finding;
searching for the selected data pattern within source data including patient records;
identifying a context of a predetermined range around each data pattern match found within the source data;
training a classifier based on an association between the identified contexts and the desired medical finding; and
using the trained classifier to automatically identify likely instances of the desired medical finding from within subsequent data including patient records.

2. The method of claim 1, wherein the data pattern is selected from one or more words or regular expressions relating to the desired medical finding.

3. The method of claim 1, wherein the one or more words or regular expressions are selected from a description of the desired medical finding.

4. The method of claim 1, wherein the predetermined range is a fixed number of words or characters preceding and following the data pattern.

5. The method of claim 1, wherein the source data includes a medical image and the data pattern is a particular image filter, shape, or other image appearance.

6. The method of claim 5, wherein the predetermined range is a surrounding area or volume of a fixed perimeter about the data pattern.

7. The method of claim 1, wherein the desired medical finding is a diagnosis, condition, symptom or other medical concept of interest.

8. The method of claim 1, wherein the source data includes structured data indicating whether or not the desired medical finding is present and the subsequent data does not include structured data indicating whether or not the desired medical finding is present.

9. The method of claim 8, wherein the structured data indicates that the medical finding exists for a particular patient, for a particular document within the electronic medical records of the particular patient, within an image within the electronic medical records of the particular patient, or within a particular context of the electronic medical records of the particular patient.

10. The method of claim 1, wherein the classifier is trained using a machine learning technique.

11. The method of claim 1, additionally including adding to the subsequent data, structured data indicating whether or not the desired medical finding is present.

12. A method for automatically labeling unstructured data from electronic medical records using a computer-based medical data processing system, comprising:
receiving patient medical data that does not include structured data indicating whether or not a desired medical finding is present;
searching for a data pattern indicative of the desired medical finding from within the patient medical data;
identifying a context of a predetermined range around each data pattern match found within the patient medical data; and
using a trained classifier to automatically identify whether the patient medical data has the desired medical finding based on the identified contexts, wherein the trained classifier was generated based on an association between identified contexts and the desired medical finding within training data.

13. The method of claim 12, wherein using a trained classifier to automatically identity whether the patient medical data has the desired medical finding based on the identified contexts includes automatically identifying whether a particular document of the patient medical data has the desired medical findings.

14. The method of claim 12, wherein using a trained classifier to automatically identity whether the patient medical data has the desired medical finding based on the identified contexts includes automatically identifying whether a particular section of text within a particular document of the patient medical data has the desired medical findings.

15. The method of claim 12, wherein the data pattern is selected from one or more words or regular expressions relating to the desired medical finding.

16. The method of claim 15, wherein the one or more words or regular expressions are selected from a description of the desired medical finding.

17. The method of claim 12, wherein the predetermined range is a fixed number of words or characters preceding and following the data pattern.

18. The method of claim 12, wherein the desired medical finding is a diagnosis, condition, symptom or other medical concept of interest.

19. The method of claim 12, wherein the training data includes structured data indicating whether or not the desired medical finding is present and the patient medical data does not include structured data indicating whether or not the desired medical finding is present.

20. The method of claim 12, additionally including adding to the patient medical data, structured data indicating whether or not the desired medical finding is present.

21. A computer system comprising:
a processor; and
a program storage device readable by the computer system, embodying a program of instructions executable by the processor to perform method steps for automatically labeling unstructured data from electronic medical records, the method comprising:
selecting a data pattern based on a desired medical finding;
searching for the selected data pattern within source data including patient records;
identifying a context of a predetermined range around each data pattern match found within the source data;
training a classifier based on an association between the identified contexts and the desired medical finding using a machine learning technique; and
using the trained classifier to automatically identify likely instances of the desired medical finding from within subsequent data including patient records.

22. The computer system of claim 21, wherein the source data includes structured data indicating whether or not the desired medical finding is present and the subsequent data does not include structured data indicating whether or not the desired medical finding is present.

23. The computer system of claim 21, additionally including adding to the subsequent data, structured data indicating whether or not the desired medical finding is present.

24. A method for determining contextual phrases that are indicative of a particular medical finding using a computer-based medical data processing system, comprising:
selecting a data pattern based on a desired medical finding;
searching for the selected data pattern within source data including patient records;
identifying a context of a predetermined range around each data pattern match found within the source data; and
generating a set of associations between the contexts identified around each of the plurality of data pattern matches of the source data and the desired medical finding.
